(19) United States
(12) Patent Application Publication
(10) Pub. No.: US 2020/0326524 A1
(43) Pub. Date: Oct. 15, 2020

(54) Methods for clearing specimens used in optical microscopy

(71) Applicant: Hempstead Halide, Inc., Galviston, TX (US)

(72) Inventors: Thomas E. Hays, Galviston, TX (US); Arthur F. F. Hays, Galviston, TX (US)

(21) Appl. No.: 16/382,567

(22) Filed: Apr. 12, 2019

(51) Int. Cl. G02B 21/34; G01N 1/30

(52) U.S. Cl. CPC G02B 21/34; G01N 1/34; G01N 1/30

(57) ABSTRACT

Disclosed is a new type of clearing solution. In one embodiment, the disclosed clearing solution is a chlorobutanol in a base solution; wherein the base solution is a concentrated solution of lactic acid in water with a range of concentrations between eighty and ninety-two percent (80-92%). Suitably, the clearing solution is made in three steps. First, a base solution with a concentration of eighty to ninety-two percent (80-92%) of lactic acid in water is prepared. Second, the base solution is located at twenty degrees centigrade (20° C.). Finally, three percent (3%) by weight of chlorobutanol is dissolved in the lactic acid and water base solution.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The disclosed subject matter is in the field of substances and related methodologies for clearing the microscopic structures of biological specimens for better resolution in optical microscopy.

Chemical Listing

Chlorobutanol—1,1,1-Trichloro-2-methylporpan-2-ol (a.k.a. Chlorbutol) CAS No. 57-15-8; EC No. 200-317-6; PubChem No. 5977. Molecular formula: C₄H₇Cl₃O. Melting point: 95-99° C. (203-210° F.) Boiling point: 167° C. (333° F.). Index of refraction: 1.491 20° C. (68° F.);

Chloral Hydrate—2,2,2-Trichloroethane-1.1-diol; CAS No. 302-17-0; EC No. 206-117-5; PubChem No. 2707. Molecular formula: C₂H₃Cl₃O₂. Melting point: 57° C. (134.6° F.) Boiling point: 98° C. (208.4° F.) at sea level.

### Background of the Invention

“Optical microscopy” is the art of using visible light and a system of lenses to magnify images of specimens or parts of specimens that cannot be seen by the unaided human eye. “Clearing” is a term of art in optical microscopy that means to increase the clarity and transparency of surface layers of specimens so that internal layers of the specimen are more directly visible through an optical microscope. A “clearing solution” or “clearing agent” is any substance, typically a fluid, capable of clearing a specimen.

Clearing a specimen enables the literal viewing of the subsurface structures of a specimen via a microscope. As a result, clearing a specimen is often a less expensive and less complicated technique for viewing the specimen's subsurface structures than other techniques that use electron microscopes and non-visible light to infer a specimen's subsurface structures. The need for various types of “clearing solutions” is therefore apparent.

The industry standard type of clearing solution is well known in the art as a saturated solution of chloral hydrate in concentrated lactic acid in water (also known as “acidified solutions of chloral hydrate”). This type of clearing solution is often used as a clearing agent for botanical specimens because it is good at removing dark-colored and light-scattering suberin from the specimen's epidermis and periderm cell walls. Villani, et al, “An Improved Clearing and Mounting Solution to Replace Chloral Hydrate in Microscopic Applications,” Applications in Plant Sciences 2013 1(5): 1300016. Suberin is a complex polyester biopolymer component of plant epidermis and periderm cell-walls forming a protective barrier against the passage of water and water bourn solutes. Id. Suberin has an opaque structure that forms a total or partial barrier against the passage of light. Id. Without removing this suberin via a clearing solution, cells lying beneath the epidermis and periderm cell walls are obscured when the specimen is viewed through a microscope. Id.

Unfortunately, the industry standard clearing solution is typically prepared outside of the United States of America because chloral hydrate is heavily regulated as a “Controlled Substance” under U.S. laws. See Controlled Substances Act, Title 21 U.S.C. ch. 13 § 801 et seq, Schedule IV. Heavy regulation makes it difficult and expensive to obtain and store chloral hydrate for preparing clearing solutions. Thus, a need exits for alternative types of clearing solutions that do not involve ingredients that are as heavily regulated as ingredients for the industry standard clearing solution. Lux et al, “An Improved Method for Clearing and Staining Free-Hand Sections and Whole-mount Samples,” Ann Bot 2005 November: 96(6): 989-996. It is preferred to have clearing solutions with a greater clarifying effect than the industry standard clearing solution.

### SUMMARY OF THE INVENTION

In view of the foregoing, an object of this specification is to disclose a new type of clearing solution and related methodologies. In one embodiment, the disclosed clearing solution is chlorobutanol in a base solution; wherein the base solution is a concentrated solution of lactic acid in water with a range of concentrations between eighty and ninety-two percent (80-92%).

Suitably, the clearing solution is made in three steps. First, a base solution with a concentration of eighty to ninety-two percent (80-92%) of lactic acid in water is prepared. Second, the base solution is located at about twenty degrees centigrade (20° C.). Finally, about three percent (3%) by weight of chlorobutanol is dissolved in the lactic acid and water base solution.

In use, about seventy-eight (78) grams of lactic acid may be mixed with about nineteen (19) grams of water to form a base solution. About three (3) grams of chlorobutanol may be dissolved in the base solution at an ambient temperature. A specimen may be immersed in the solution at about seventy degrees centigrade (70° C.) and maintained at that temperature for one hour. The specimen is then removed from the solution and washed thoroughly in water. The specimen may be pressed and dried. The specimen 1000 may be mounted on a microscope slide. Finally, the specimen may be viewed through an optical microscope to observe and take advantage of the enhanced visibility resulting from the use of the solution.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 1 is the chemical structure of chlorobutanol;

FIG. 2 is a diagram of a clearing process;

FIG. 3 is a magnified photographic image of an uncleared specimen; and,

FIG. 4 is a magnified photographic image of a specimen cleared with an industry standard clearing solution; and,

FIG. 5 is a magnified photographic image of a specimen cleared with a clearing solution of the present specification.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

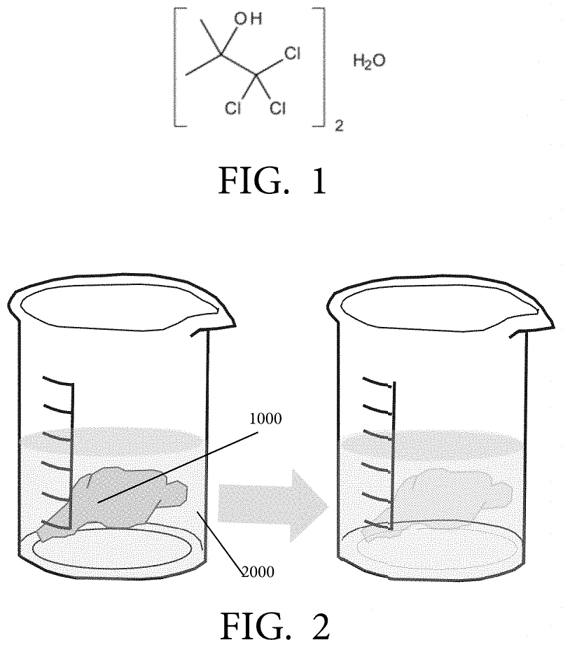

Generally disclosed is a clearing solution defined by chlorobutanol in a base solution. Chlorobutanol (1,1,1-Trichloro-2-methylpropan-2-ol; 1,1,1-Trichloro-2-methyl-2-propanol; CAS No. 57-15-8; PubChem 5977) is a chemical with the formula C₄H₇Cl₃O (also written C(sub.4)H(sub.7)Cl(sub.3)O). An image of the structure of chlorobutanol is provided as FIG. 1. The base solution is a concentrated solution of lactic acid in water with a range of concentrations between eighty and ninety-two percent (80-92%).

Suitably, the clearing solution is made in three steps. First, a base solution with a concentration of a range of about eighty to ninety-two percent (80-92%) of lactic acid in water is prepared. The concentration of lactic acid in water may vary within this range. However, the solubility of chlorobutanol in a lactic acid and water solutions decreases as the proportion of water increases (Chlorobutanol in water is 1.5 grams per liter, 1.5% w/w and the introduction of lactic acid as in the range suggested as the base solution doubles that solubility to 3 grams per liter of the base solution or 3.0% w/w (w/w—In respect of percentages, a symbol indicating the particular percentage referred to was derived by dividing the weight of the component in issue by the weight of the entire composition of which it is a part)). So, concentrations outside this range are not preferred. Second, the base solution is located at twenty degrees centigrade (20° C.). The temperature may be higher or lower than twenty degrees centigrade (20° C.). But, the solubility of chlorobutanol in a lactic acid and water solutions is significantly temperature dependent. Finally, about three percent (3%) by weight of chlorobutanol is dissolved in the lactic acid and water base solution. Chlorobutanol in a saturated solution with concentrated lactic act in water partially precipitate out of that solution forming undesirable crystals as the temperature goes below ambient temperatures experienced in many laboratories (e.g., temperatures in the range of twenty degrees to twenty-five degrees centigrade (20°-25° C.)). So, temperatures below twenty degrees Centigrade (20° C.) are less preferable for preparing the base solution (at a temperature greater than approximately 40° C. the solubility increases from 3.0% w/w to 6% w/w, but the extra chlorobutanol comes out of solution forming crystals at room temperature, which would be inconvenient at the least if the crystals were obscuring a specimen on a microscope slide). Three percent (3%) (or close to it) by weight of chlorobutanol in the base solution will preferably stay in solution at low room temperature, e.g., while on a microscope slide.

FIG. 2 is a diagram of the clearing process. As shown, a specimen 1000 to be cleared is immersed in the disclosed clearing solution 2000 for periods of time varying with the toughness and darkness of color of the specimen 1000. More delicate and thinner specimens 1000 suitably require less time in the solution 2000 than the time required for clearing hardier thicker specimens to the same degree. Said differently, the specimen 1000 to be cleared is immersed in the solution 2000 for such time as is required to achieve the desired degree of clearing. The result is a clearing of the specimen 1000 sufficient to allow for better viewing of underlying structures through an optical microscope (not shown) than would be possible without the use of this clearing process.

As an example of the invention but not by way of limitation seventy-eight (78) grams of lactic acid is mixed with nineteen (19) grams of water forming a base solution. The base solution is eighty percent (80%) by weight of lactic acid in water. Three (3) grams of chlorobutanol is dissolved in the base solution at an ambient temperature of approximately twenty degrees centigrade (20° C.). Referring again to FIG. 2, a thin section of a botanical specimen 1000 is immersed in the solution 2000. The solution 2000 and the immersed specimen 1000 are heated to a temperature of seventy degrees centigrade (70° C.) and maintained at that temperature for one hour after which time the specimen 1000 is removed from the solution and washed thoroughly in water. Next, the specimen 1000 is pressed and dried by any of the means used in the art for drying specimens and preventing them from distorting in shape. The specimen 1000 is mounted on a microscope slide with or without the use of a mounting medium and then viewed through an optical microscope to observe and take advantage of the enhanced visibility resulting from the use of the solution 2000 in the clearing process.

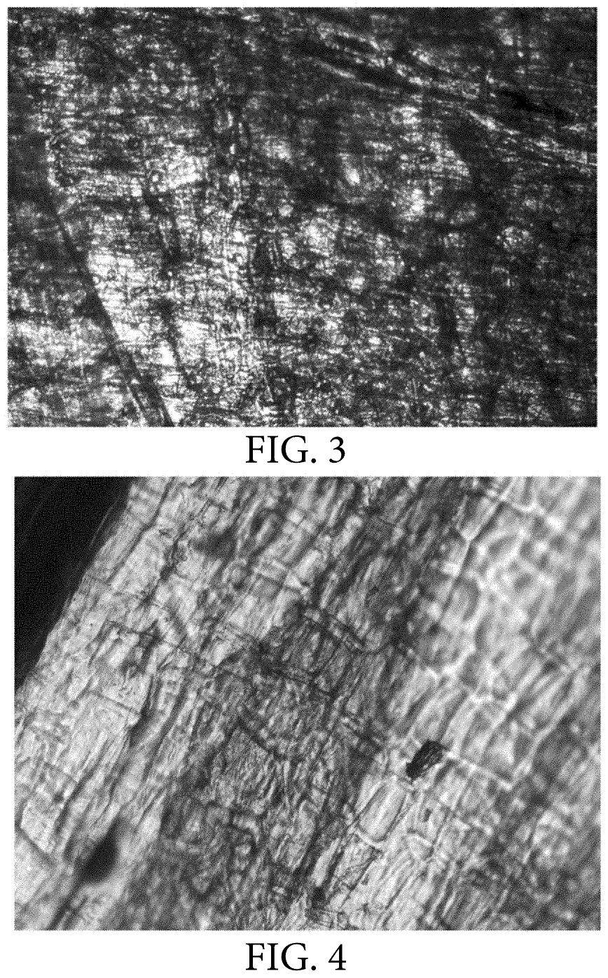

Suitably, three 6.3 mm diameter specimens were prepared from the outermost layer of one Allium cepa. FIGS. 3, 4, and 5 are photographic views of (i) an uncleared specimen, (ii) a specimen cleared using the industry standard clearing solution, and (iii) a specimen cleared using the disclosed clearing solution. As used here, the term “photographic view” refers to a still photograph taken by an AmScope MD500 microscope eyepiece camera through a Brunel (UK) monocular optical microscope at 10/0.25 magnification.

FIG. 3 shows a photographic view of a specimen that was not cleared before mounting on a microscope slide. FIG. 4 shows a photographic view of a specimen that was cleared by submerging it for one hour at seventy degrees centigrade (70° C.) in a saturated solution of chloral hydrate in a base solution comprised of ninety percent (90%) by weight of lactic acid in water and then washed and dried and mounted on a microscope slide. A comparison of FIGS. 3 and 4 demonstrates the beneficial effects of the clearing process using a saturated solution of chloral hydrate in a base solution of ninety percent (90%) lactic acid in water with the cellular structure of the specimen in FIG. 4 being more clearly visible than that of the specimen in FIG. 3.

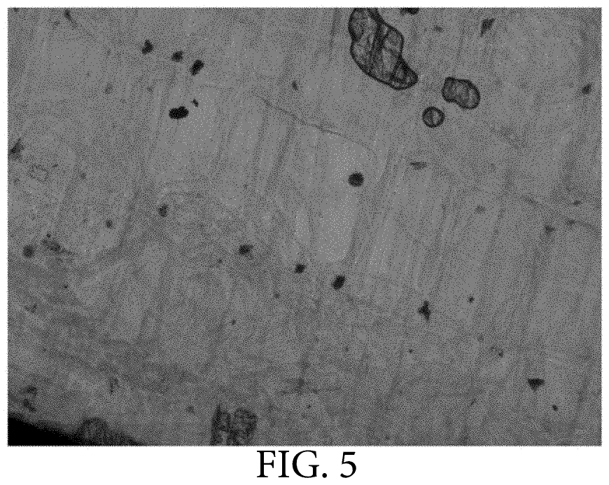

FIG. 5 shows a photographic view of a specimen that was submerged for one hour at seventy degrees centigrade (70° C.) in the solution prepared according to the above described methodologies before being washed and dried and mounted on a microscope slide. A comparison of FIGS. 3 and 5 demonstrates the beneficial effects of the clearing process using the solution prepared according to the invention with the underlying cellular structure of the specimen in FIG. 5 being more clearly visible than that of the specimen in FIG. 3. A comparison of FIGS. 4 and 5 demonstrates the beneficial clearing effect of using the solution made according to the invention in the clearing process to be as great as or greater than the beneficial clearing effect of a saturated solution of chloral hydrate in a similar base solution.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

I claim:

1. A clearing solution defined by:
chlorobutanol in a base solution; and,
wherein the base solution is defined by a concentrated solution of lactic acid in water.

2. The clearing solution of claim 1:
Wherein approximately three percent weight (3%) chlorobutanol is provided in approximately ninety-seven percent (97%) weight of the base solution.

3. The clearing solution of claim 2:
wherein the base solution is defined by a concentrated solution of lactic acid in water with a range of concentrations between eighty and ninety-two percent (80-92%).

4. A method of manufacturing a clearing solution comprising the steps of:
preparing a base solution of lactic acid in water;
observing the temperature of the base solution to be approximately twenty degrees centigrade (20° C.); and,
dissolving chlorobutanol in the lactic acid and water base solution.

5. The method of claim 4 further comprising the steps of:
preparing the base solution with a concentration of eighty to ninety-two percent (80-92%) of lactic acid in water; and,
dissolving three percent (3%) by weight of chlorobutanol in the base solution.

6. A method of observing a specimen under a microscope comprising the steps of:
mixing lactic acid with water to form a base solution;
dissolving chlorobutanol in the base solution at an ambient temperature to form a clearing solution;
heating the clearing solution to about seventy degrees centigrade (70° C.) from ambient temperature;
immersing the specimen in the clearing solution at seventy degrees centigrade (70° C.) and maintaining that temperature for one hour;
removing the specimen;
washing the specimen with water;
pressing the specimen dry;
mounting the specimen on a microscope slide; and,
viewing the specimen through an optical microscope to observe and take advantage of the enhanced visibility resulting from the use of the clearing solution.

7. The method of claim 6 further comprising the steps of:
mixing seventy-eight (78) grams of lactic acid with nineteen (19) grams of water to form the base solution;
dissolving three (3) grams of chlorobutanol in the base solution at an ambient temperature to form the clearing solution.
